(19) United States
(12) Patent Application Publication
(10) Pub. No.: US 2006/0062716 A1
(43) Pub. Date: Mar. 23, 2006

(54) Method for the surface purification of a graphite containing impurities using a dilute aqueous solution of nh4f and h2so4

(75) Inventors: Karim Zaghib, Quebec (CA); Abdelbast Guerfi, Quebec (CA); Michael Armand, Saint-Martin d'Urinage (FR); Claude Gagnon, Val-Belair (CA); Kimio Kinoshita, Cupertino, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Hydro-Quebec, Montreal (CA)

(21) Appl. No.: 10/506,212

(22) PCT Filed: Feb. 12, 2003
(86) PCT No.: PCT/CA03/00209

§ 371 Date: Oct. 21, 2005

(30) Foreign Application Priority Data
Mar. 1, 2002 (CA) 2,374,132

(51) Int. Cl. H01M 4/58; C01B 31/04

(52) U.S. Cl. 423/448; 429/231.8

(57) ABSTRACT

Process for preparing particles of graphite that are purified in surface, from particles of an impure graphite, this process comprises at least one step of treating particles of graphite by means of a diluted aqueous solution of (H₂SO₄ and NH₄F), H₂SO₄ and NH₄F each being present in the diluted aqueous solution at a weight content representing from 5 to 30% of total weight of the aqueous solution, the quantity of diluted aqueous solution representing from 70 to 95% of the weight of the particles of graphite that undergo purification.

### FIELD OF THE INVENTION

The present invention has for object a particularly efficient process for the purification of the surface of particles of graphite and more particularly of the surface of particles of natural graphite. This process, which allows the elimination of impurities such as Si, Ca, S, Fe that are present in natural graphite, at concentrations that vary depending on the supply source, comprises a step of treating the particles of graphite by means of a diluted solution of (H₂SO₄ and NH₄F), under economical reaction conditions. This treatment may be preceded by a step of mechanical treatment. The step of mechanical treatment consists in a step of crushing particles of natural graphite until obtaining particles having a predetermined granulometry distribution. The particles of graphite thus purified in surface can be used for example in the preparation of carbon-lithium based electrodes.

### PRIOR ART

The carbon-lithium based negative electrode has recently given rise to a lot of interest in the industrial as well as the scientific community. As a matter of fact, the use of such an electrode in a rechargeable battery allows to solve the crucial problem caused by the metallic lithium electrode which is not easily rechargeable in liquid electrolytes because of the growth of dendrites when the charge density (C/cm²) and/or the current density (mA/cm²) exceed the limit values that condition a good operation of the battery. This major problem has delayed the appearance of lithium batteries of standard formats (AA, C, D, etc.) intended for the public at large. The first battery of this type was marketed in the early 90's by Sony Energytech. This battery is so-called lithium-ion and comprises a negative electrode consisting of carbon-lithium.

The principle of operation of this electrode is based on the reversibiliity of lithium insertion between the layers of carbon. These layers are characterized by a very high anisotropy of the carbon-carbon binding forces inside the layers (very highly covalent) and between the layers (very weak of the Van der Waals type). Because of this, since lithium is a cation of very small size, it can diffuse rapidly between the 2D layers by forming ionic type bonds with the latter which do not result in irreversible modifications of the bonds inside the layers. Only a small spreading between the layers is noted, thus allowing to accommodate the inserted lithium.

It is well known that the reversibility of the electrochemical insertion of lithium in carbon is the more specially favorable that the Li⁺ cation is deprived of its solvation sphere during its transfer from the electrolytic solution towards the interior of solid carbon. Thus, the co-insertion of DMSO and DME results in a more important separation of the planes (>300%) thus contributing to a larger disorganization of the hostess structure. The thus inserted lithium additionally has an apparent weight and volume that is more important, which reduces its mobility as well as its maximum concentration inside the planes. On the other hand, in a propylene carbonate medium, the ternary compound is very unstable, the solvent being reduced into gaseous propene which can result in a violent degradation of the battery.

More recently, it has been shown that carbons with imperfect crystallinity (turbostratic) could insert lithium in PC or PC-DME medium without co-intercalation of the solvent. The difference in electrochemical behavior of a highly crystalline graphite and a carbon that is not well crystallized such as coke treated at a temperature lower than 1800° C., could be caused by a propene release overvoltage that is more important in the case of coke. However, a first discharge step results in the formation of a protector film at the surface of the granular particles of carbon, which is a product that is obtained by decomposition of the solvent. Once it is formed, this film has an impedance that is sufficient to prevent the transfer of electron that is necessary for the progression of reduction of the solvent. But, it is however conductor through the Li⁺ ions and because of this it behaves as a solid electrolyte. It is also highly probable that this film takes part in the de-solvation of the Li⁺ ion during its transfer and/or its reduction at the carbon surface.

The electricity that is consumed during this step cannot be recovered when the current is reversed. The faradic yield of the 1^{st} cycle is consequently low. The reversible capacity measured during the following cycles is directly bound to the nature of carbon and to the treatment that it has undergone as well as to the nature of the electrolyte.

U.S. Pat. No. A-5,082,818 deals with 1-40 μm graphites. This study is based on the relation between structure and electrochemistry. However, no information is found that relates to the purity of graphite powder, or still its process of preparation.

U.S. Pat. No. A-5,756,062 discusses the modification of the surface of a highly purified graphite. The graphite used is however not a crude graphite directly obtained from a mineral. The chemical modification of the graphite is carried out by treatments based on fluorine, chlorine or phosphorus.

The graphite that is conventionally used as electrode material in a lithium-ion battery is generally obtained from 2 distinct sources, namely synthetic graphite, or possibly thermally highly purified natural graphite, preferably at temperatures higher than 2500° C. Such a graphite, although of excellent quality, is however extremely costly, which has a direct incidence on the final product that is eventually sold on the market. Moreover, the graphite is only reduced in powder form after having been purified or synthesized, which causes some problems during the crushing process. Indeed, a homogenous distribution of the particles in the powder is highly altered, since graphite in pure state is very fragile. In fact, one can consider that it has a relatively non-homogenous distribution. If a battery is directly manufactured with a graphite having such a non-homogenous distribution, it is clear that its life span will be greatly reduced. The alternative is then to filter the graphite in order to retain only the particles having the desired size, which results in additional steps of the process, and ultimately, an increase of the cost of the resulting material.

In International Application PCT/CA 01/00233, a process was recently proposed allowing purification, for example in surface of graphite particles by implementing a process including at least one step of crushing graphite until obtaining a size distribution between 1 and 50 μm, followed by a step of purifying the particles obtained by chemical means preferably by using an acid treatment preferably with HF or a fluorinated derivative allowing the production of HF in the medium, and/or by heat treatment at temperatures typically between 1000 and 3000° C. Although it has important advantages with respect to the prior processes, this process recommends, as illustrated by the embodiments reported in PCT Application CA 01/00233, the use of important quantities of an acid reactant. These quantities, expressed in weight, are at least 3 times higher than that of the graphite particles to be treated. This process is associated with relatively high exploitation costs and possibilities of degradation of the internal structure of the graphite particles, as often takes place during an exfoliation.

There was therefore a need for providing a process allowing the surface purification of graphite particles under economical conditions of exploitation and without damaging the initial structure of graphite. In a preferred embodiment, the process should make it possible to obtain a graphite powder with a relatively homogenous size distribution.

### SUMMARY OF THE INVENTION

The present invention relates to a process for the preparation of particles of graphite that is purified in surface, from graphite particles. This process including at least on step of treating the particles of graphite at a temperature between room temperature and 95 ° C., for a period of 5 minutes to 6 hours, by means of an aqueous mixture of H₂SO₄ and NH₄F, H₂SO₄ and NH₄F each being present in the aqueous mixture in a weight content representing from 5 to 30% of the total weight of the aqueous mixture of H₂SO₄ and NH₄F, the quantity of aqueous mixture representing from 70 to 95% by weight of the total weight of the particles of graphite that are subject to purification.

### BRIEF DESCRIPTION OF THE FIGURES

FIG. 1/5 represents the experimental installation used to carry out the purification treatment according to an embodiment of the present invention.

FIG. 2/5 represents the size distribution carried out with impure graphite for which the treatment is described in example A hereinafter.

FIG. 3/5 represents the size distribution carried out with purified graphite obtained at the end of the treatment described in example A hereinafter.

FIG. 4/5 represents the size distribution carried out with the impure graphite for which the treatment is described in example B hereinafter.

FIG. 5/5 represents the size distribution carried out with purified graphite obtained at the end of the treatment described in example B hereinafter.

### DETAILED DESCRIPTION OF THE INVENTION

A first object of the present invention consists in a process for preparing particles of graphite that are purified in surface from particles of graphite (preferably natural graphite) that contain impurities, whose size is preferably between about 1 and 375 μm, more preferably still between 1 and 50 μm, said process including at least one step of treating said particles of graphite at a temperature between room temperature and 95 ° C., preferably at a temperature between 40 and 90 ° C., more preferably still at a temperature of about 60 ° C., for a period of 5 minutes to 6 hours, preferably for a period of 10 minutes to 4 hours, by means of a diluted aqueous solution of (H₂SO₄ and NH₄F), H₂SO₄ and NH₄F each being present in the diluted aqueous solution at a weight content representing from 5 to 30% of the total weight of the diluted aqueous solution, the quantity of diluted aqueous solution representing from 70 to 95% by weight, preferably from 80 to 90% of the weight of the particles of graphite that are subject to purification, said treatment being preferably carried in a reactor, advantageously in the presence of a mechanical stirrer preferably of the planetary mixer type, and the diluted aqueous solution of (H₂SO₄ and NH₄F) preferably being introduced in the reaction mixture at the same time as the particles of graphite that are subject to purification.

A second object of the present invention consists in a process for preparing particles of graphite that are purified in surface from particles of graphite (preferably natural graphite) whose size is preferably between about 1 and 375 μm, more preferably still between 1 and 50 μm, said process including:
a) a step of preparing, preferably at room temperature and under preferably mechanical stirring, a reaction mixture containing said particles of graphite (preferably natural graphite), NH₄F, H₂SO₄ (preferably at 96%) and water, H₂SO₄ and NH₄F each being present in the diluted aqueous solution of (H₂SO₄ and NH₄F) that is formed, at a weight content of 5 to 30%, the quantity of diluted aqueous solution representing from 70 to 95% by weight, preferably from 80 to 90% by weight of the weight of said particles of graphite;
b) at least one step of treating the mixture prepared in step a) at a temperature between room temperature and 95° C., preferably at a temperature between 40 and 90° C., for a period of 5 minutes to 6 hours, preferably for a period of 10 minutes to 4 hours, by means of the diluted aqueous solution of (H₂SO₄ and NH₄F), said treatment preferably being carried out in the presence of a mechanical stirring that is preferably of the planetary mixer type;
c) a step of separation, preferably by filtering, of the liquid phase and the solid phase that are present in the treated mixture obtained in step b);
d) a step of washing the solid phase that is recovered in step c) by means of a solvent, preferably by means of an aqueous solvent that is preferably water;
e) a step of removing the impurities that are extracted from the surface of graphite and that are found in the liquid phase recovered in step c) and/or in the washing solution that is recovered in step d); and
f) an optional step of recycling the purified liquid phase that is recovered in step e), preferably after enrichment in H₂SO₄ and in NH₄F, during step a) and/or during step b) of said process.

According to an advantageous embodiment of the processes of the invention, the particles of graphite subject to purification are obtained by crushing a graphite until obtaining particles of a size between about 1 and 50 μm.

Preferably, the diluted aqueous solution of (H₂SO₄ and NH₄F) that is used comprises from 5 to 30% of H₂SO₄ and from 5 to 30% of NH₄F, it is added preferably at the start of the purification treatment, under mechanical stirring, the residual acid mixture is neutralized preferably in situ, preferably with NaOH or by complete dilution with H₂O, and the temperature is preferably kept constant when carrying out the process.

According to an advantageous embodiment, the crystallographic structure of graphite is unchanged before and after leaching as shown for example by a control of the crystallographic parameters L_{c} and Lₐ of graphite carried out respectively by X ray diffraction and by Raman spectroscopy.

The types of graphite that are advantageously used, alone or in admixture, within the scope of the processes of the invention are:
graphite of the type StratminGraphite (Canada), rich in calcium;
graphite of the Chinese type, rich in silicon;
graphite of the type Lake Knife (Canada), rich in sulfur; and
graphite of the Brazilian type, rich in iron impurities and all worldwide source.

According to an advantageous embodiment, steps (a) and (b) are carried out under conditions suitable to give particles of graphite having one of more of the following additional properties:
an interplanar distance d₀₀₂ measured by X-ray, that varies between 3.35 Å and 3.38 Å;
a specific surface that varies between 0.4 and 55 m²/g; and
a coefficient of purity measured by backscattering with the secondary electrons that varies between 98.5% and 99.99%.

Purification is preferably carried out in a bath preferably an aqueous bath.

According to an advantageous variant, the particles of purified graphite obtained during said process are, in an additional step, conditioned in the form of a carbon anode for an electrochemical generator comprising an alkaline or alkaline-earth metal. Preferably, the metal is lithium.

The anode may advantageously be prepared by mixing the particles of graphite with a binder and with a solvent, and by spreading the mixture obtained on a metallic collector.

Purification, on the other hand, is carried out so as to remove said impurities and the corrosion sites in surface only.

Preferably, an oxidizing acid that is preferably of the type NHO₃ is added in the reaction mixture to obtain an exfoliated and purified (in surface) graphite in a single step.

According to this process, H₂SO₄ is present in the diluted aqueous solution of (H₂SO₄ and NH₄F) at the rate of at least 80% by weight of the total weight of (H₂SO₄ and NH₄F) and NH₄F is present in the diluted aqueous solution of (H₂SO₄ and NH₄F) at the rate of at most 20% by weight of the total weight of (H₂SO₄ and NH₄F).

Still more advantageously, the temperature/time gradient, during treatment, is between 10 and 90 degrees Celsius per hour.

A third object of the present invention consists of particles of non purified natural graphite of a size between about 1 and 50μm and whose surfaces have no impurity nor corrosion site, said particles being obtained by one of the processes according to the present invention.

A fourth object of the present invention consists of carbon anodes based on particles of graphite that can be obtained by one of the processes according to the invention.

The preferred anodes are those obtained by means of particles of crushed and purified natural graphite comprising at least one of the following additional properties:
an interplanar distance d₀₀₂ obtained by X-ray that varies between 3.35 Å and 3.38 Å;
a specific surface that varies between 0.4 and 55 m ²/g; and
a coefficient of surface purity measured by backscattering with the secondary electrons, that varies between 98.5% and 99.99%.

A fifth object of the present invention consists of electrochemical batteries comprising an anode according to the present invention.

Among the batteries according to the invention that are particularly performing, those of the lithium-ion type may be mentioned.

The present invention that relates to a new process for purifying the surface of graphite particles constitutes an improvement of the process generally described in PCT Application CA 01/00233. The content of PCT/CA 01/00233 Application is incorporated in the present application by reference.

While PCT/CA 01/00233 Application illustrates the use of the method of purifying graphite under strong energetic and reactive conditions, namely a treatment temperature of the order of 90 to 250° C. and a duration of acid treatment of at least 180 minutes, it has surprisingly been found that a selection of certain operating parameters that differ from those previously identified as preferred allows to obtain better purification yields, and moreover, under more interesting economical conditions.

A new method was thus drawn up to produce purified graphite in the form of small particles that can be used in an electrochemical battery, for example of the lithium-ion type, while having a relatively homogenous size distribution. Such a graphite may also be used in other types of applications as electronic conductor in a cathode (batteries) or in combustion batteries in the nuclear field.

The present invention concerns a method for the chemical purification of the impurities that are found at the surface of an impure graphite such as natural graphite, exactly where the passivation film will be formed. The present method allows to remove the impurities that are capable of being prejudicial to the formation of the passivation film and to the cycling of the carbon-lithium anode. The crushing process is carried out before purification since it allows to obtain a better control of the size and distribution of the particles, hence a more homogeneous powder requiring no filtering to remove particles that are too large or too small.

The subsequent purification step aims essentially at removing from the surface of the particles of graphite, the impurities that are responsible for electronic conductivity, such as the compounds comprising silicon and iron. These compounds are also responsible for doping and reduction through lithium of the compounds that contain same. These phenomena should absolutely not be present, or at least they should be highly minimized, in the passivation film that will be formed at the surface of the electrode, since the latter will cause a degradation of the efficiency of the battery, and ultimately a short-circuit. On the other hand, the presence at the surface of impurities promoting ionic conductivity, such as calcium fluoride, has no negative influence on the performances of the graphite electrode because of its strong ionic character which has little effect on a conductivity of electronic nature.

The impurities that are present in a graphite mineral are generally the following (in a decreasing order): Si >Ca >Fe >S >Al. As previously mentioned, the compounds comprising silicon must be removed since on the one hand, lithium reduces or dopes the compounds comprising silicon (for example SiO₂, SiO and Si metal), and on the other hand, the silicon compounds are electronic conductors. This latter property is totally incompatible with the properties of the passivation film, which represents a key-element of a good carbon-lithium anode that is characterized by a long life span.

A first embodiment of the invention consists in a process for preparing graphite particles that are purified in surface, from graphite particles (preferably natural graphite) including impurities, of a size that is preferably between 1 and 375 μm, more preferably still between 1 and 50 μm. This process includes at least one step of treating said particles of graphite at a temperature between room temperature and 95° C., preferably at a temperature between 40 and 90° C., more preferably still at about 60° C., for a period of 5 minutes to 6 hours, preferably for a period of 10 minutes to 4 hours, by means of a diluted aqueous solution of (H₂SO₄ and NH₄F), H₂SO₄ and NH₄ each being present in the diluted aqueous solution at weight content representing from 5 to 30% of the total weight of the diluted aqueous solution, the quantity of diluted aqueous solution representing from 70 to 95% by weight, preferably 80 to 90% by weight of the particles of graphite subject to purification, said treatment being preferably carried out in a reactor, advantageously in the presence of a mechanical stirring preferably of the planetary mixer type, and the diluted aqueous solution of (H₂SO₄ and NH₄F) is preferably introduced into the reaction mixture at the same time as the particles of graphite that are subject to purification.

A second preferred embodiment of the present invention consists in a process for preparing particles of graphite that are purified in surface from graphite particles (preferably natural graphite) including impurities, of a size preferably being between 1 and 375 μm, more preferably still between 1 and 50 μm, said process including:
a) a step of preparing, preferably at room temperature and under mechanical stirring, a reaction mixture containing said particles of graphite (preferably natural graphite), NH₄F, H₂SO₄ (preferably at 96 %) and water, H₂SO₄ and NH₄F each being present in the diluted aqueous solution of (H₂SO₄ and NH₄F) that is formed, at a weight content of 5 to 30%, the quantity of diluted aqueous solution representing from 70 to 95% by weight, preferably from 80 to 90% by weight of said particles of graphite;
b) at least one step of treating the mixture prepared in step a) at a temperature between room temperature and 95° C., preferably at a temperature between 40 and 90° C., more preferably still at a temperature of about 60° C., for a period of 5 minutes to 6 hours, preferably for a period of 10 minutes to 4 hours, by means of the diluted aqueous solution of (H₂SO₄ and NH₄F) that is formed, said treatment being preferably carried out in the presence of a mechanical stirring that is preferably of the planetary mixer type;
c) a step of separating, preferably by filtering, the liquid phase and the solid phase that are present in the treated mixture obtained in step b);
d) a step of washing the solid phase that is recovered in step c) by means of a solvent, preferably by means of an aqueous solvent that is preferably water;
e) a step of removing impurities that are extracted from the surface of the graphite and that are present in the liquid phase that is recovered in step c) and/or in the washing solution that is recovered in step d);
f) a step of recycling the purified liquid phase that is recovered in step e), preferably after enrichment in H₂SO₄ and in NH₄F, in step a) and/or in step b) of said process.

Preferably, H₂SO₄ is present in the diluted aqueous solution of (H2SO₄ and NH₄) at the rate of at least 80% by weight of the total weight of (H₂SO₄ and NH₄) and NH₄F is present in the aqueous solution at the rate of at most 20% by weight of the total weight of (H₂SO₄ and NH₄).

The present method of purification does not modify the size of the granules as determined by the crushing process. There is therefore no agglomeration of the particles. These particles are therefore free and thus form a homogeneous mixture with the binder in order to obtain an electrode of good quality (roughness, thickness, porosity, etc).

The step of crushing may be carried out according to any technique known to one skilled in the art. Such techniques include for example jet milling, air milling and ball milling.

The following examples are given to show the performances and advantages of the process of the present invention, for example with respect to the process described in PCT Application CA 01/00233. They should in no way be interpreted as bringing any kind of limitation to the scope of the object of the present invention.

### EXAMPLE ACCORDING TO THE PROCESS DESCRIBED IN PCT/CA01/00233

### Example 1

30 grams of a natural graphite StratminGraphite (Lac des îles—Québec) having an initial particle size of 375 μm are crushed by an “air-milling” process until the particles reach a size of 10 μm. The average size obtained for the particles (D50%) is 10.52 μm. The Gaussian distribution of graphite has a single maximum without any shoulder. The size distribution was determined by means of the Microtrac™ particle analyzer manufactured and sold by Leeds & Northrul. Methanol was used as carrier liquid. Subsequently, the crushed graphite was leached in a reactor filled with 106.5 ml of an aqueous bath of HF 30%. The temperature of the mixture was fixed to 90° C., and the leaching time was 180 minutes. The graphite was thereafter filtered, washed with full water, and the powder was dried during 24 hours at 120° C.

The graphite powder obtained is analyzed by backscattering coupled with EDX. No exfoliation of the particles was observed. On the other hand, EDX analysis shows that most of the remaining impurities consist of calcium. Purity of this sample is 99.6%, as obtained by the method of analysis of the remaining ashes from the impurities.

This graphite is mixed with the fluorinated polyvinylidene binder (PVDS) (Kruha: KF-1700) and n-methyl pyrolidone in a weight ratio of 90:10. This mixture is applied on a copper collector by the Doctor Blade™ method.

The graphite electrode thus obtained is dried under vacuum at 120° C. during 24 hours and is mounted in a button cell of the 2035 type. A Celgard™ 2300 separator soaked with the electrolyte 1M LiPF₆+EC/DMC: 50/50 (ethylene carbonate+dimethyl carbonate) is used. Metallic lithium is used as reference and as counter-electrode.

Electrochemical tests were carried out at room temperature. Curves of discharge—charge were obtained between 0 and 2.5 volts in C/24. The first coulomb yield is 85%, which is higher than commercial graphite used in lithium-ion batteries (typically 81%). The reversible capacity is 365 mAH/g which is equivalent to x=0.98 in LiₓC₆. This obtained value is very close to the theoretical value for graphite (372 mAh/g). No negative effect associated with the presence of the residual impurities of Ca is noted.

### Example 2

30 grams of a natural graphite StratminGraphite (Lac des îles—Québec) having an initial particle size of 375 μm are crushed by an “air-milling” process until the particles reach a size of 10 μm. The graphite is then leached in a bath consisting of 106.5 ml of an aqueous mixture comprising 30% H₂SO₄ and 30% HF. Then, 106.5 ml of the acid mixture is heated to 90° C. and 30 g of graphite are then added to the solution. The graphite is leached during 180 minutes in the reactor. The solid is thereafter filtered, washed in full water, and dried at 120° C. during 24 hours. The size (D50%) of the particles obtained is 10.92 mm, and this before and after purification. The gaussian distribution of graphite has a single maximum, without any shoulder.

An analysis of the impurities of this graphite by EDX shows a major presence of the elements Ca and F. An analysis of the residual ashes from the impurities present in and at the surface of graphite shows a purity of 99.68%. Preparation of the electrode and electrochemical tests are carried out according to the procedure described in example 1.

The coulomb efficiency of the first cycle is 90%. The irreversible plateau of the passivation film is normally formed at about 800 mV. This means that the elements Ca, F or CaF₂ did not influence the formation of the passivation film. The reversible capacity of the graphite is 356 mAh/g, which is equivalent to x=0.96 in LiₓC₆. formation.

### Example 3

30 grams of a natural graphie StratminGraphite (Lac des îles—Québec) are treated similarly as in example 2 except for the acid concentration of HF which, in the aqueous bath, is now 20%. An analysis of the impurities of this graphite by EDX shows the major presence of the elements Ca and F. An analysis of the residual ashes from the impurities that are present in and at the surface of the graphite shows a purity of 99.75%. The preparation of the electrode and the electrochemical tests are identical to the procedures described in example 1.

Coulomb efficiency of the first cycle is 89%. The irreversible plateau of the passivation film is normally formed at about 800 mV. The reversible capacity of the graphite is 365 mAh/g and the equivalent of x=0.98 according to the formation of LiₓC₆.

### Example 4

30 grams of a natural graphite StratminGraphite (Lac des îles—Québec) are treated similarly as in example 2, except for the acid concentration in the aqueous bath, that is now 10% HF. Preparation of the electrode and electrochemical tests are identical to the procedures described in example 1.

The coulomb efficiency of the first cycle is 75%. The irreversible capacity of 106.7 mAh/g is very high compared to that of the graphite of example 2 and 3, respectively leached with HF 30% and HF 20%. The reversible capacity is 318 mAh/g and is equivalent to x=0.85 in the formation of LiₓC₆.

### Example 5

30 grams of a natural graphite StratminGraphite (Lac des îles—Québec) are treated similarly as in example 2, except for the mixture H₂SO₄-HF in which HF is replaced by NH₄F. The aqueous solution of H₂SO₄ and NH₄F, therefore includes 30% H₂SO₄ and 30% NH₄F.

The aqueous mixture of (H₂SO₄ and NH₄F) content represents, as in the preceding examples, about 3 times the weight of the treated granules of graphite.

Treatment with the acid solution is carried out at 90° C. during 3 hours.

An analysis of the impurities of this graphite by EDX shows the major presence of the elements Ca and F. An analysis of the residual ashes of the impurities on this graphite shows a purity of 99.64%. Preparation of the electrode and electrochemical tests are identical to the procedures described in example 1.

The coulomb efficiency of the first cycle is 90%. The irreversible capacity of graphite is 44 mAh/g. The reversible capacity is 352 mAh/g and is equivalent to x=0.96 in the formation of LiₓC₆.

### Example 6

30 grams of a natural graphite StratminGraphite (Lac des îles—Québec) consisting of particles having a size of 10 μm are leached in two stages. First, with an aqueous solution of 30% HCl, then with an aqueous solution of 30% HF. For each leaching, 106.5 ml of the acid solution are heated at 90° C., and 30 g of graphite are then added. The graphite is leached during 180 minutes in the reactor. The solid is filtered, washed with full water, and dried at 120° C. during 24 hours.

The size (D50%) is 10.02 μm. The gaussian distribution of the graphite has a single maximum without any shoulder.

An analysis of the impurities of this graphite by EDX shows a total absence of the elements Si and Ca. The main element obtained as impurity is sulfur. An analysis of the residual ashes from the impurities on graphite shows a purity of 99.99%. Preparation of the electrode and electrochemical tests are identical to the procedures described in example 1.

The coulomb efficiency of the first cycle is 88%. The irreversible plateau of the passivation film is normally formed at about 800 mVolts. It may therefore be concluded that the presence of sulfur has no bad effects when the passivation film is formed. The reversible capacity of graphite is 357 mAh/g and is equivalent to 3=0.96 in the formulation of LiₓC₆.

### EXAMPLES OF USING THE PURIFICATION PROCESS ACCORDING TO THE INVENTION

For each test, 150 g of a graphite that originates from Brazil, i.e. rich in impurities (in quantity of decreasing importance) of the type Al, Si and Fe, are placed in a reactor. The average size of the particles of graphite (D50) is 20 μm. Leaching is carried out for 4 hours. A sample of 50 g is taken after 1, 2 and 4 hours, to check kinetic evolution. An analysis of the ashes is then completed on each sample. The results of these analyses are given in the following paragraphs.

First, an aqueous solution containing 1.5% by weight of NH₄F and 15% by weight of H₂SO₄; was tested at different temperatures. The percentage of aqueous solution of NH₄F and of H₂SO₄ used represents 20% by weight of the weight of graphite treated. The results are presented in the following table. Each sample that is analyzed is identified by a test number.

| | | | | % ashes | | | |
|---|---|---|---|---|---|---|---|
| | NH₄F | H₂SO₄ | T | Time | | | |
| Test | (%) | (%) | (° C.) | 0 h | 1 h | 2 h | 4 h |
| 1-3 | 1.5 | 15 | 20 | 1.88 | 0.31 | 0.25 | 0.22 |
| 4-6 | 1.5 | 15 | 60 | 1.88 | 0.08 | 0.05 | 0.03 |
| 7-9 | 1.5 | 15 | 90 | 1.88 | 0.01 | 0.01 | 0.01 |

At 90° C., the reaction is very fast, even at low concentrations of NH4F. It can be seen that the reaction is nearly complete at 60° C. By increasing the NH4F concentrations, the following results have been obtained at 60 and 20° C. It is surprisingly noted that the intended level for the surface purification of the particles of graphite, i.e. an amount of impurities lower than or equal to 0.03%, is reached by proceeding at a temperature lower than 90° C. and preferably of the order of 60° C.

| | | | | % ashes | | | |
|---|---|---|---|---|---|---|---|
| | NH₄F | H₂SO₄ | T | Time | | | |
| Test | (%) | (%) | (° C.) | 0 h | 1 h | 2 h | 4 h |
| 10-12 | 2.5 | 15 | 60 | 1.88 | 0.09 | 0.06 | 0.02 |
| 13-15 | 15 | 15 | 20 | 1.88 | 0.09 | 0.05 | 0.03 |
| 16-18 | 5 | 5 | 60 | 1.88 | 0.08 | 0.06 | 0.05 |

By comparing tests 12 and 18, both carried out at 60° C., it appears that a decrease of the acid concentration has an important impact. Indeed, residual ash percent is higher with more NH₄F and less H₂SO₄. Test 15 at 20° C., shows that, even with a very strong concentration of the two reactants, the reaction is still not completed after 4 hours.

It therefore appears surprisingly that particularly interesting performances are obtained by carrying out the purification treatment with small quantities of an aqueous solution that is weakly acid and at a temperature between room temperature and about 60° C.

It also surprisingly appears that the time of treatment may be substantially decreased when operating at temperatures near 90° C.

### EXAMPLES OF USE OF THE PROCESS ACCORDING TO THE INVENTION WITH PARTICLES OF GRAPHITE OF SPHERICAL SHAPE

### Example A

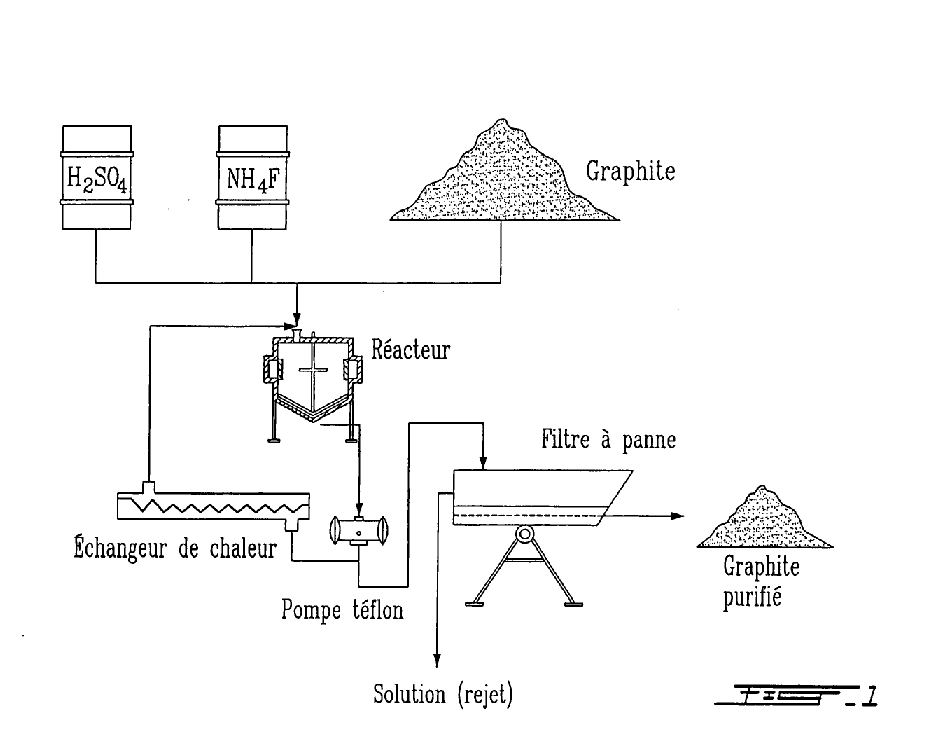

The experimental installation used is represented in FIG. 1. It comprises for example a polypropylene reactor, a graphite exchanger and a pump made of teflon. In view of the presence of the toxic gas HF, special safe pieces of equipment are used, such as a full-face mask with cartridge for HF, an apron, boots and rubber gloves.

85.6 liters of water are first placed in the reservoir, and 16.15 kg of H₂SO₄ (96%) are thereafter added. If the acid that is available is not at 96%, the volume of water is adjusted accordingly to obtain a final solution at 15% H₂SO₄. For example, for 15.8 kg of a 98% acid, 86 liters of water are added and for 15.8 kg of a 93% acid 85.1 liters of water are added. The water addition should be carried out slowly to prevent the reaction from being too violent.

A quantity of 1.55 kg of NH₄F is then added into sulfuric acid. The solution is thereafter heated at 90° C. with the graphite exchanger. Then, 20 kilograms of a spherical Chinese graphite obtained by Mechano-fusion (Hozokawa) whose size is 12 μm, are added in the solution and the mixture obtained is stirred.

The operating mixture is kept at 90° C. during 1 hour, and the solid portion is filtered and washed with a large amount of water. The solution that is recovered is then neutralized with lime.

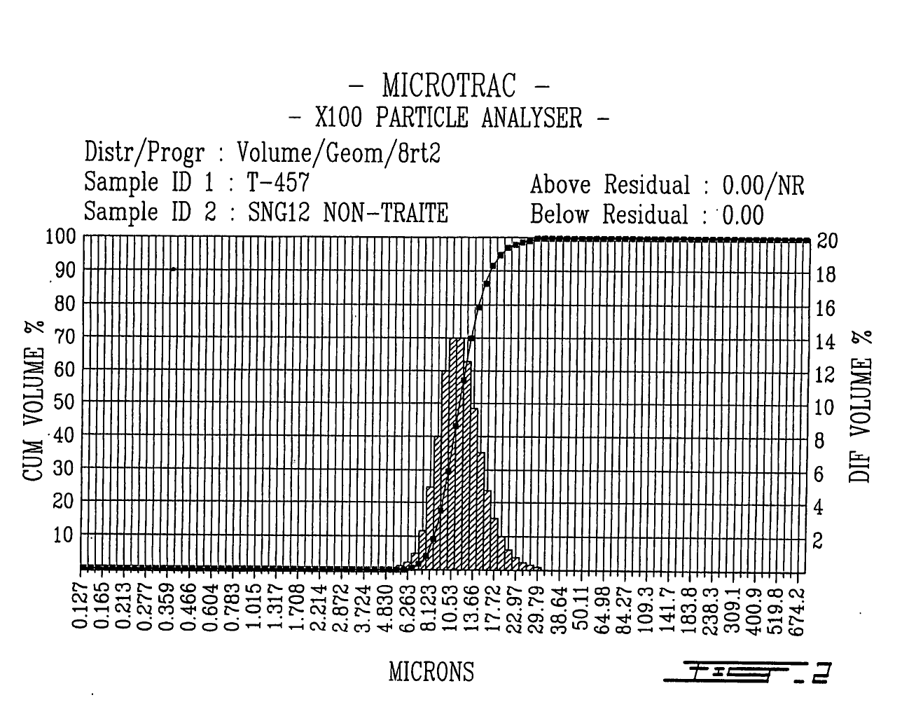

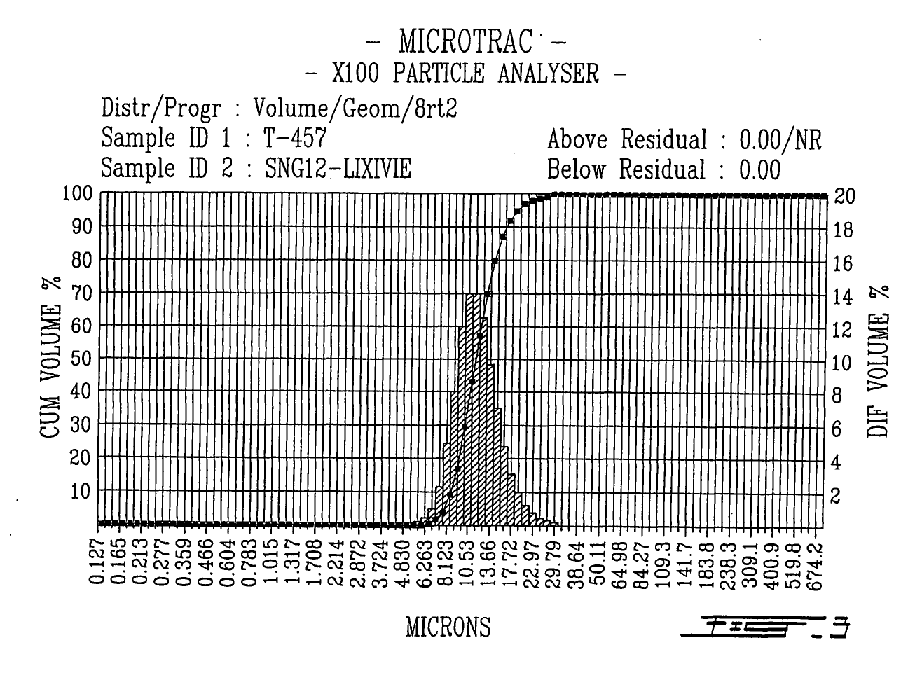

As shown by the experimental results reported in FIGS. 2 and 3 annexed hereto, the total purity of the particles of graphite which was 96.9% before treatment, reaches a value of 99.4% after treatment according to the process of the invention.

### Example B

The same installation and the same safety pieces of equipment as in example A were used. The same operation sequence is repeated with a second sample of 20 kg and with particles of graphite whose size is 20 μm obtained by Mechano-fusion (Hozokawa).

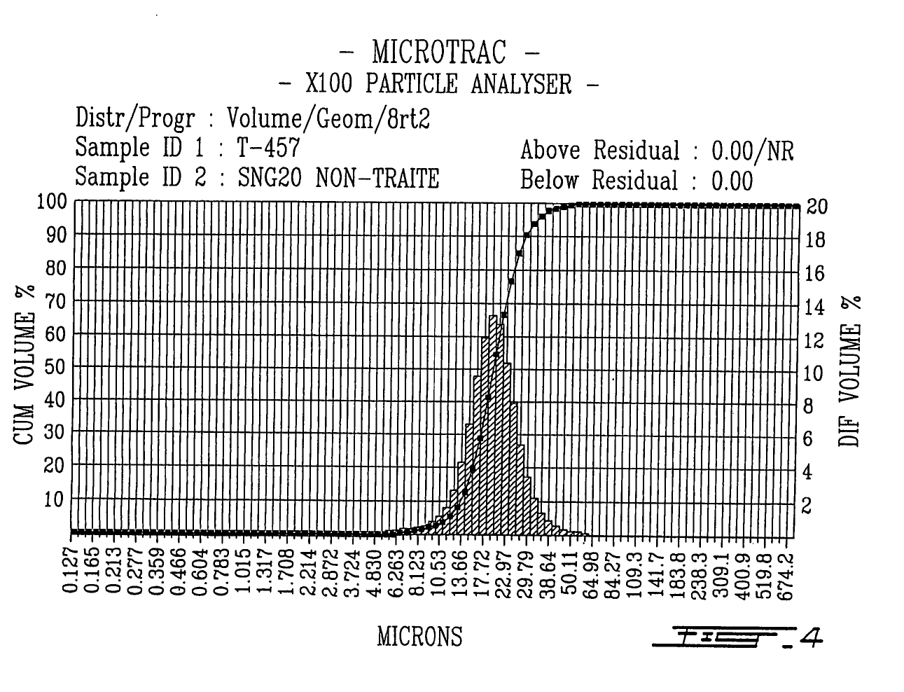

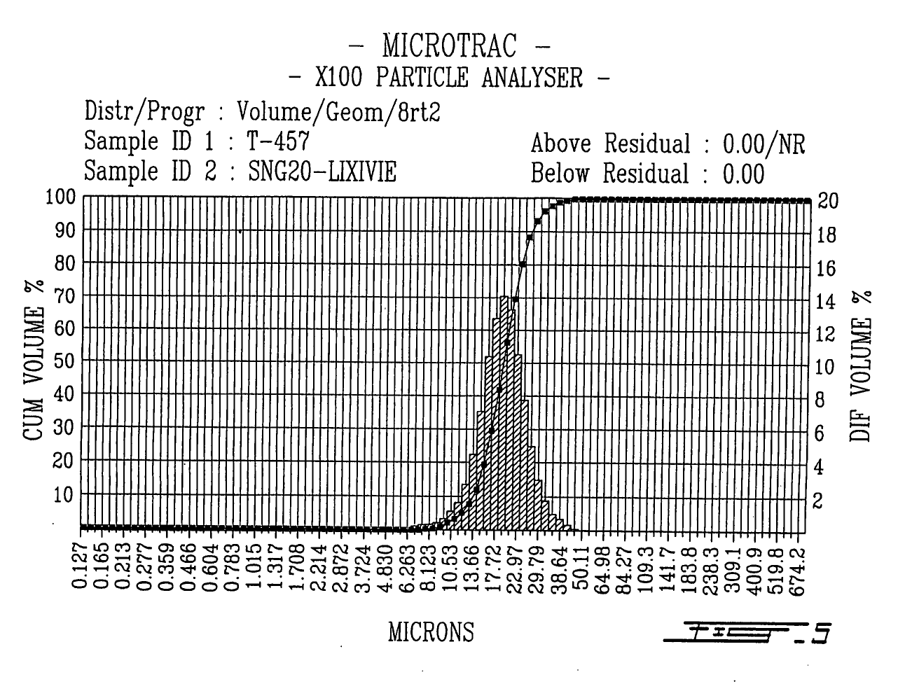

As shown by the experimental results reported in FIGS. 4 and 5 annexed hereto, the total purity of the particles of graphite which was 97% before treatment, reaches a value of 99.1% after treatment according to the process of the invention.

Although the present invention was described by means of specific operating steps, it is understood that many variations and modifications may be associated with these steps, and the present application aims at covering such modifications, uses and adaptations of the present invention, following in general the principles of the invention and including any variation of the present description which will become known or conventional in the field of activity in which this application is found, and that may be applied to the above mentioned essential elements, in accordance with the following claims.

1. Process for preparing particles of graphite that are purified in surface, from particles of graphite that contain impurities, said process including at least one step of treating said particles of graphite, by means of a diluted aqueous solution of (H₂SO₄ and NH₄F), H₂SO₄ and NH₄F each being present in the diluted aqueous solution in an amount by weight representing 5 to 30% of the total weight of the diluted aqueous solution, the quantity of diluted aqueous solution used for the treatment representing 70 to 95% by weight of the total weight of the particles of graphite that are subjected to purification.

2. Process according to claim 1, in which the particles of graphite to be purified are particles of a natural graphite.

3. Process according to claim 1, in which the particles of graphite have a size between 1 and 375 μm.

4. Process according to claim 3, in which the size of the particles of graphite to be purified is between 1 and 50 μm.

5. Process according to claim 1, in which the step of treating particles of graphite is carried out at a temperature between room temperature and 95° C.

6. Process according to claim 5, in which the treatment is carried at a temperature between 40 and 90° C.

7. Process according to claim 6, in which the treatment of the particles of graphite is carried out at a temperature of about 60° C.

8. Process according to claim 1, in which the treatment of the particles of graphite is carried out for a period of 5 minutes to 6 hours.

9. Process according to claim 8, in which the treatment of the particles of graphite is carried out for a period of 10 minutes to 4 hours.

10. Process according to claim 1, in which the quantity of diluted aqueous solution in the treatment step represents from 80 to 90% of the total weight of the particles of graphite that are subjected to purification.

11. Process according to claim 1, carried out in a reactor, in the presence of mechanical stirring.

12. Process according to claim 11, in which the mechanical stirring is of the planetary mixer type.

13. Process according to claim 1, in which the diluted aqueous solution of (H₂SO₄ and NH₄F) is introduced into the reaction mixture at the same time as the particles of graphite that are subjected to purification.

14. Process for preparing particles of graphite that are purified in surface from particles of impure graphite, said process including:
a) a step of preparing a reaction mixture containing said particles of impure graphite, NH₄F, H₂SO₄ and water, H₂SO₄ and NH₄F each being present in the diluted aqueous solution of (H₂SO₄ and NH₄F) that is formed, at a weight content of 5 to 30%, the quantity of diluted aqueous solution representing from 70 to 95% by weight of the weight of said particles of graphite;
b) at least one step of treating the mixture prepared in step a) at a temperature between room temperature and 95° C., for a period of 5 minutes to 6 hours, by means of the diluted aqueous solution of (H₂SO₄ and NH₄F);
c) a step of separation of the liquid phase and the solid phase that are present in the treated mixture obtained in step b);
d) a step of washing the solid phase that is recovered in step c), by means of a solvent;
e) a step of removing the impurities that are extracted from the surface of graphite and that are found in the liquid phase recovered in step c) and/or in the impurities that are present in the washing solution that is recovered in step d).

15. Process according to claim 14 including an additional step of recycling the purified liquid phase that is recovered in step e), in step a) and/or in step b) of said process.

16. Process according to claim 14, for the preparation of particles of natural graphite that are purified in surface.

17. Process according to claim 14, in which the particles of graphite to be purified have a size between about 1 and 375 μm.

18. Process according to claim 17, in which the particles of graphite to be purified have a size between 1 and 50 μm.

19. Process according to claim 14, in which step a) is carried out at room temperature and under mechanical stirring.

20. Process according to claim 14, in which the quantity of diluted aqueous solution (H₂SO₄ and NH₄F) that is added during step a) represents 80 to 90% of the total weight of said particles of graphite.

21. Process according to claim 14, in which the treatment of the mixture prepared during step a) is carried out at a temperature between room temperature and 95° C.

22. Process according to claim 14, in which step a) and/ or step b) last(s) from 5 minutes to 6 hours.

23. Process according to claim 22, in which the duration is from 10 minutes to 4 hours.

24. Process according to claim 14, in which step b) is carried out in the presence of mechanical stirring.

25. Process according to claim 14, in which the solvent, used in step d) for washing the solid phase, is water.

26. Process according to claim 14, in which the purified liquid phase that is recovered in step a) is enriched in H₂SO₄ and in NH₄F, in step a) and/or in step b) of said process, before recycling.

27. Process according to claim 1, in which the particles of graphite that are subject to purification were obtained by crushing a graphite until obtaining particles of a size between about 1 and 50 μm.

28. Process according to claim 1, comprising at least one of the following characteristics:
the diluted aqueous solution of (H₂SO₄ and NH₄F) used, comprises from 5 to 30% of H₂SO₄ and from 5 to 30% of NH₄F;
the diluted aqueous solution of (H₂SO₄ and NH₄F) used, is added at the start of the purification treatment, under mechanical stirring;
the residual acid mixture is neutralized preferably in situ with NaOH or by complete dilution with H₂O; and
the temperature is kept constant during the entire duration of the process.

29. Process according to claim 1, wherein the crystallographic structure of the graphite is unchanged before and after leaching as shown by a control of the crystallographic parameters L_{c} and L_{z} of the graphite carried out respectively by X ray diffraction and/or by Raman spectroscopy.

30. Process according to claim 1, wherein the graphite is selected from the group consisting of a StratminGraphite (Canada) type rich in calcium, graphites of the Chinese type rich in silicon, a graphite of Lake Knife (Canada) rich in sulfur, graphites of the Brazilian type rich in impurities of the iron type and any available graphite from a natural source.

31. Process according to claim 2, wherein steps (a) and (b) are carried out under conditions suitable to give particles of graphite having at least one of the following additional properties:
an interplanar distance d₀₀₂ obtained by X-ray that varies between 3.35 Å and 3.38 Å, all included;
a specific surface that varies between 0.4 and 55 m²/g, all included; and
a coefficient of surface purity measured backscattering with the secondary electrons that varies between 98.5% and 99.99%, all included.

32. Process according to claim 1, wherein the purification is carried out in a bath, preferably in an aqueous bath.

33. Process according to claim 1, wherein the purified particles of graphite obtained in the course of said process are, in a supplementary step, conditioned in the form of a carbon anode for rechargeable electrochemical generator comprising an alkaline or alkaline-earth metal.

34. Process according to claim 33, characterized in that the metal is lithium.

35. Process according to claim 33 wherein the anode is prepared by mixing the particles of graphite with a binder and with a solvent, and in that the mixture obtained is spread on a metallic collector.

36. Process according to claim 1, wherein the purification is carried out so as to remove said impurities and the corrosion sites, in surface only.

37. Particles of non purified natural graphite of a size between about 1 and 50 μm and whose surfaces contain no impurity and no corrosion site, said particles being capable of being obtained by one of the processes according to claim 1.

38. Carbon anode based on particles of graphite according to claim 37.

39. Anode according to claim 38, characterized in that the crushed and purified particles of graphite comprise at least one of the following additional properties:
an interplanar distance d₀₀₂ obtained by X-ray that varies between 3.35 Å and 3.38 Å, all included;
a specific surface that varies between 0.4 and 55 m²/g, all included; and
a coefficient of surface purity measured by backscattering with the secondary electrons that varies between 98.5% and 99.99%, all included.

40. Electrochemical battery comprising an anode according to claim 38.

41. Battery according to claim 40, characterized in that it is of the lithium-ion type.

42. Process according to claim 1, in which an oxidizing acid is added in the reaction mixture to obtain, in a single step, exfoliated and purified graphite (in surface).

43. Process according to claim 42, in which the oxidizing acid if of the HNO₃ type.

44. Process according to claim 1, in which H₂SO₄ is present in the diluted aqueous solution of (H₂SO₄ and NH₄F) at the rate of at least 80% by weight of the total weight of (H₂SO₄ and NH₄F) and NH₄F is present in the diluted aqueous solution of (H₂SO₄ and NH₄F) at the rate of at most 20% by weight of the total weight of (H₂SO₄ and NH₄F).

45. Process according to claim 1, in which during treatment the temperature/time gradient is between 10 and 90 degrees Celsius per hour.

46. Process according to claim 14, in which step c) is a step of filtering of the liquid phase and the solid phase that are present in the treated mixture obtained in step b).

47. Process according to claim 28, in which the residual acid mixture is neutralized in situ with NaOH or by complete dilution with H₂O.

48. Process according to claim 32, characterized in that the purification is carried out in an aqueous bath.
